(19) United States
(12) Patent Application Publication
(10) Pub. No.: US 2021/0291097 A1
(43) Pub. Date: Sep. 23, 2021

(54) GROW-ROOM/GREENHOUSE AIR FILTER HOUSING

(71) Applicant: Ricardo Murcio, Apple Valley, CA (US)

(72) Inventor: Ricardo Murcio, Apple Valley, CA (US)

(21) Appl. No.: 17/084,763

(22) Filed: Oct. 30, 2020

Related U.S. Application Data
(60) Provisional application No. 62/990,546, filed on Mar. 17, 2020.

(51) Int. Cl. B01D 46/00; A01G 9/24

(52) U.S. Cl. CPC B01D 46/0005; A01G 9/246; B01D 2279/50; B01D 2265/06; B01D 2265/027

(57) ABSTRACT

A reusable filter encasement for air handlers of grow rooms is described. The encasement amounts to a housing configured to contain a filter which is designed to be replaced at regular intervals in order to ensure adequate clean air flow within the growing facility. The housing is preferably equipped with a quick access mechanism such as zippers and/or hook-and-loop fasteners, which enable to easy exchange of filters by a single technician, rather than requiring additional assistance. Straps are preferably present within the housing to further ensure that the filter remains in the correct seated position. Clasps are present on the straps to facilitate access to the filter after the housing has been opened via the zippers and/or hook-and-loop fasteners.

### CONTINUITY

This application is a non-provisional application of provisional patent application No. 62/990,546, filed on Mar. 17, 2020, and priority is claimed thereto.

### FIELD OF THE PRESENT INVENTION

The present invention relates to the field of indoor gardening and ventilation, and more specifically relates to an air filter housing configured to facilitate and expedite the exchange of filters for an indoor air handler conventionally used in the ventilation of large grow room setups.

### BACKGROUND OF THE PRESENT INVENTION

In large-scale grow rooms and greenhouses, ventilation is critical for the plants to thrive. Generally, air handlers are employed to circulate and filter air within the grow room. These air handlers are equipped with at least one fan, and at least one filter. Conventionally, the air filter must be removed and replaced at regular intervals to ensure adequate performance. The filters are also known to manage foul or unwanted smells which may be present in some grow operations.

Unfortunately, the air filters disposed in most industrial air handlers are cumbersome to replace. Usually, the air filters are difficult to remove from their required position, often requiring technicians to pull the filter down with tremendous force in order to remove the old filter. Conventionally, these filters are carbon-based filters, and are found hanging from ceiling-mounted air handlers, or disposed within ducts disposed on the ceiling. As such, the position of the filter makes accessing the filters difficult. This, paired with their rigidity due to the carbon content makes them incredibly difficult to remove and subsequently replace by just one person. If there were a new form of filter housing that was equipped with removable fasteners, such as a zipper, Velcro™, or similar hook-and-loop fasteners, the job of replacing industrial large-scale grow room filters could be expedited and facilitated.

Thus, there is a need for a new form of air filter housing configured for use with industrial, large-scale grow room air handlers. Such a housing is preferably equipped with at least one zipper which facilitates easy access to a filter disposed within the housing. Such a housing is preferably equipped with straps that enable the replacement filter to be easily fitted into position, and then zipped into place until replacement is needed.

### SUMMARY OF THE PRESENT INVENTION

The present invention is an air filter housing configured for use in tandem with industrial, large-scale grow room and/or greenhouse air handlers. The housing is preferably equipped with at least one easy access zipper configured to enable filter exchange by only one individual. The zipper is preferably disposed centrally on the housing. At least one strap is preferably present within the housing to retain the filter within the housing, even when the zipper is opened for filter replacement. The at least one strap may easily be released via at least one clasp to provide for the removal of a dirty filter from the housing.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention as seen from below.

FIG. 2 exhibits a view of the apparatus of the present invention as seen from the top.

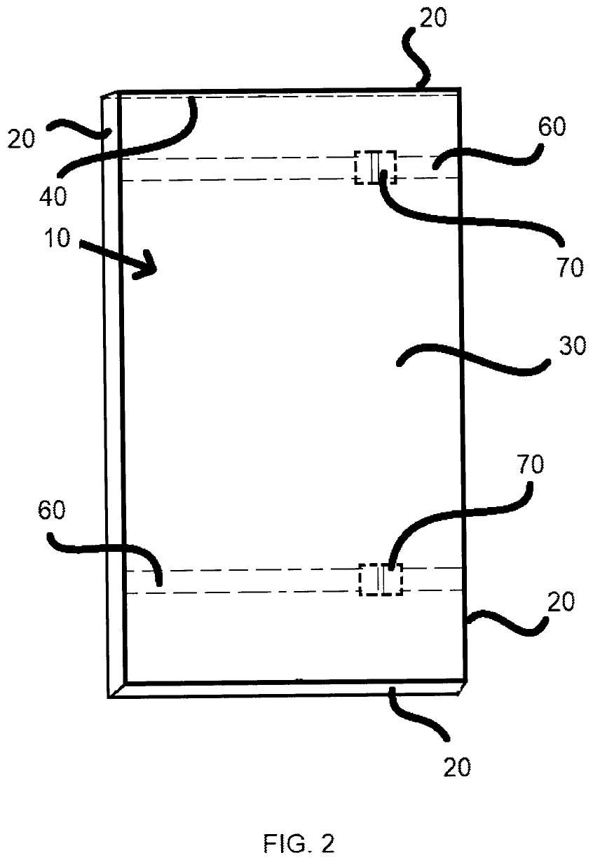

FIG. 3 shows a flow chart detailing the process of use of the present invention by a user.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

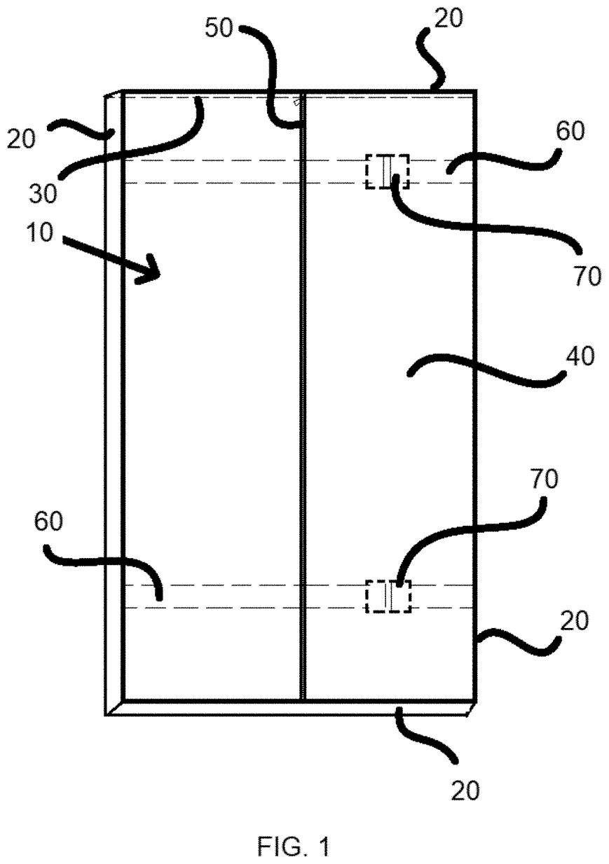

The present invention is an air filter housing configured for use with conventional, large-scale, industrial air handlers generally installed in grow rooms such as those used for indoor gardening, hydroponics, and the like. The preferred embodiment of the present invention includes a housing (10) having four side walls (20), a top panel (30), and a bottom panel (40). The bottom panel (40) is preferably equipped with at least one zipper (50) configured to provide easy access to an air filter which is held in position between the four side walls (20), top panel (30) and bottom panel (40). The at least one zipper (50) preferably bifurcates the bottom panel (40) as shown in FIG. 1.

When the at least one zipper (50) is closed, the housing (10) is secured, and the filter remains firmly in position. When replacement of the filter is necessary, a technician unzips the at least one zipper (50) to facilitate access to the filter contained within the housing (10) for easy removal. As the filter employed in such grow room setups are generally carbon-based filters, they are often fairly rigid, necessitating forceful removal. However, with the apparatus of the present invention, the filter may be easily removed, either via cutting the filter, or simply wedging the filter through the bottom panel (40) after the at least one zipper (50) is opened.

Straps (60) are preferably present within the housing (10) to ensure that the filter further remains in position throughout the installation process. The straps (60) of the present invention are preferably equipped with at least one clasp (70), such as a buckle, pinch-clip, hook, or similar conventional attachment mechanism, which provides for quick and easy release of the straps (60) when exchange of a dirty filter is required from the housing (10).

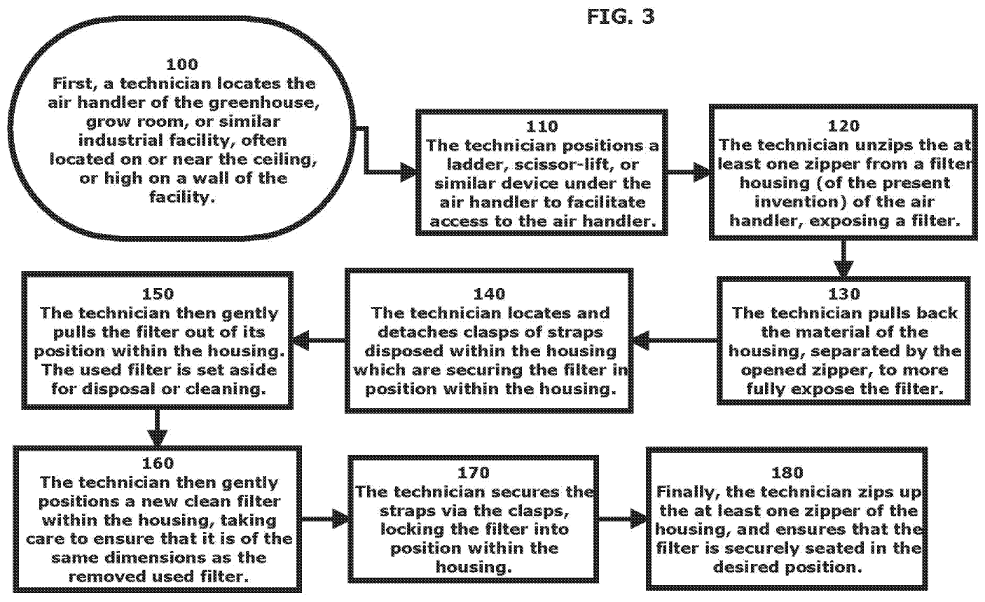

The process of use of the system and apparatus of the present invention, as shown in FIG. 3, is preferably as follows:

1. First, a technician locates the air handler of the greenhouse, grow room, or similar industrial facility, often located on or near the ceiling, or high on a wall of the facility. (100)

2. The technician positions a ladder, scissor-lift, or similar device under the air handler to facilitate access to the air handler. (110)

3. The technician unzips the at least one zipper from a filter housing (of the present invention) of the air handler, exposing a filter. (120)

4. The technician pulls back the material of the housing, separated by the opened zipper, to more fully expose the filter. (130)

5. The technician locates and detaches clasps of straps disposed within the housing which are securing the filter in position within the housing. (140)

6. The technician then gently pulls the filter out of its position within the housing. The used filter is set aside for disposal or cleaning. (150)

7. The technician then gently positions a new clean filter within the housing, taking care to ensure that it is of the same dimensions as the removed used filter. (160)

8. The technician secures the straps via the clasps, locking the filter into position within the housing. (170)

9. Finally, the technician zips up the at least one zipper of the housing, and ensures that the filter is securely seated in the desired position. (180)

In some embodiments of the present invention, the dimensions of the housing (10) are prone to differ depending upon the air handler and filter dimensions to which the present invention is to be installed. Similarly, the thickness of the housing (10) may vary in accordance with the thickness of the filter to be disposed within the housing (10) after installation.

It should be noted that the straps (60) of the present invention are preferably elastic to facilitate a tight fit against the filter disposed within the housing (10). Additionally, it should be understood that some embodiments of the present invention may employ Velcro™ or similar hook-and-loop type fasteners in lieu of, or in addition to at least one zipper (50). The hook and loop fastener preferably extends from one side of the bottom panel (40) of the housing (10) to the other, along a primary axis of the apparatus. Some embodiments of the present invention may include straps (60) which are integrated into the filter itself, and are configured to attach to (or interlock with) straps (60) of the housing (10) of the present invention. These integrated straps (60) may be present in the form of elastic or stretchable bands.

Filters designed for use with the system and apparatus of the present invention are preferably available in a variety of types, including carbon filters, disposable filters, reusable filters, micro filters, HEPA filters, etc.

It should be noted that alternate embodiments of the present invention may have the at least one zipper (50) disposed in varying locations on the housing (10) in contrast to those shown in the figures. Similarly, additional straps (60) may be present.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A reusable filter encasement for industrial air handlers used in plant grow operations comprising:
a housing, said housing equipped with four side walls, a top panel, and a bottom panel;
wherein said housing is configured to contain the reusable filter;
at least one zipper, said at least one zipper disposed on said bottom panel;
wherein closure of said at least one zipper secures the reusable filter within said housing;
wherein opening of said at least one zipper facilitates access to the reusable filter wherein said at least one zipper facilitates removal and exchange of the reusable filter;
straps, said straps disposed within said housing;
wherein said straps are attached to said housing;
wherein said straps are configured to secure the reusable filter within said housing until said at least one zipper is closed to more securely maintain the reusable filter within said housing; and
wherein said top panel is disposed in communication with an intake of the air handler.

2. The apparatus of claim 1, further comprising:
at least one hook and loop fastener, said at least one hook and loop fastener extending across a bottom of said bottom panel along a primary axis of said housing.

3. The apparatus of claim 1, wherein said straps are elastic.

4. A reusable filter encasement for industrial air handlers used in plant grow operations comprising:
a housing, said housing equipped with four side walls, a top panel, and a bottom panel;
wherein said housing is configured to contain the reusable filter;
at least one hook-and-loop fastener, said at least one hook-and-loop fastener disposed on said bottom panel;
wherein closure of said at least one hook-and-loop fastener secures the reusable filter within said housing;
wherein opening of said at least one hook-and-loop fastener facilitates removal and exchange of the reusable filter;
straps, said straps disposed within said housing;
wherein said straps are attached to said housing;
wherein said straps are configured to secure the reusable filter within said housing until said at least one hook-and-loop fastener is closed to more securely maintain the reusable filter within said housing; and
wherein said top panel is disposed in communication with an intake of the air handler.

5. The apparatus of claim 4, wherein said at least one hook and loop fastener extends along a primary axis of said bottom panel of said housing.

6. The apparatus of claim 4, wherein said at least one hook and loop fastener is configured to maintain the filter in a stationary position within said housing.

7. The apparatus of claim 4, wherein said straps are elastic.

8. The apparatus of claim 5, wherein said straps are elastic.

9. The apparatus of claim 5, wherein said straps are completely enclosed within said housing when said hook and loop fastener is closed.
